(19) United States
(12) Patent Application Publication
(10) Pub. No.: US 2026/0299613 A1
(43) Pub. Date: Oct. 1, 2026

(54) MOVING-BODY CONTROL METHOD, MOVING-BODY CONTROL DEVICE, MOVING BODY, AND NON-TRANSITORY COMPUTER-READABLE STORAGE MEDIUM

(71) Applicant: HONDA MOTOR CO., LTD., Tokyo (JP)

(72) Inventors: Sango MATSUZAKI, Wako-shi (JP); Misa KOMURO, Wako-shi (JP); Akane AIZAWA, Wako-shi (JP)

(21) Appl. No.: 19/570,644

(22) Filed: Mar. 18, 2026

(30) Foreign Application Priority Data
Mar. 25, 2025 (JP) 2025-050507

(51) Int. Cl. G05D 1/686; G06T 7/70; G05D 105/70; G05D 109/10; G05D 111/10; G05D 111/30

(52) U.S. Cl. CPC G05D 1/686; G06T 7/70; G05D 2105/70; G05D 2109/10; G05D 2111/10; G05D 2111/32; G06T 2207/30196

(57) ABSTRACT

A control method for controlling a moving body comprises identifying position information related to a position of a specific person; determining, based on the position information, whether the specific person is in a first area where the moving body does not operate or a second area where the moving body operates; and transmitting, when it has been determined that the specific person is in the first area, recognition information indicating that the moving body has recognized the specific person.

### CROSS-REFERENCE TO RELATED APPLICATIONS

This application claims priority to and the benefit of Japanese Patent Application No. 2025-050507 filed on Mar. 25, 2025, the entire disclosure of which is incorporated herein by reference.

### BACKGROUND OF THE INVENTION

### Field of the Invention

The invention relates to a moving-body control method, a moving-body control device, a moving body, and a non-transitory computer-readable storage medium.

### Description of the Related Art

There is a known moving body that follows or leads a user and autonomously travels, such as a robot. Japanese Patent Laid-Open No. 2019-204414 discloses a technique for tracking a user while avoiding objects. Japanese Patent Laid-Open No. 2021-068096 discloses a moving body that tracks a user when a user is in a forward area and does not move when the user is in a dead zone area set in the vicinity of the moving body.

However, the above technique has a problem that since the moving body stops when the user is in the dead zone area, and the user cannot determine whether the moving body has recognized the user, which causes the user to feel anxiety.

### SUMMARY OF THE INVENTION

The invention has been made in view of the above problem, and an object thereof is to provide a technique related to a moving body capable of reducing a user’s anxiety.

According to an aspect of the present invention, there is provided a control method for controlling a moving body, the moving-body control method comprising: identifying position information related to a position of a specific person; determining, based on the position information, whether the specific person is in a first area where the moving body does not operate or a second area where the moving body operates; and transmitting, when it has been determined that the specific person is in the first area, recognition information indicating that the moving body has recognized the specific person.

### BRIEF DESCRIPTION OF THE DRAWINGS

FIG. 1 is a perspective view illustrating an entire configuration of a moving body;

FIG. 2 is a schematic plan view illustrating a traveling unit of a moving body;

FIG. 3 is a block diagram of a control system of a moving body;

FIG. 4 is a functional block diagram illustrating functions of a control unit;

FIG. 5 is a plan view for explaining a dead zone area, a response area, and a traveling area;

FIG. 6 is a diagram illustrating an image displayed as recognition information on a front display unit when a user is in front.

FIG. 7 is a diagram illustrating an image displayed as recognition information on a front display unit when a user is on the right side.

FIG. 8 is a flowchart illustrating a processing flow of drive control processing according to an embodiment;

FIG. 9 is a flowchart illustrating a processing flow of drive control processing according to a first modification; and

FIG. 10 is a flowchart illustrating a processing flow of drive control processing according to a second modification.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### Embodiment

In the following embodiments, a case of using a micro mobility vehicle as an example of a moving body will be described as an example. A micro mobility vehicle is, for example, a small-sized electric vehicle capable of carrying baggage and following or leading a user (also referred to as a specific person). However, the present embodiment may be applied to a micro mobility vehicle capable of carrying not only baggage but also passengers. In addition, the present embodiment is not limited to an example in which the moving body is an electric vehicle, and is applicable to any moving body other than the electric vehicle. Furthermore, in the following description, a moving body including one driven wheel will be described as an example, but the driven wheel is not necessarily provided, and the number of driven wheels is not limited to one and may be two or more.

The moving body such as a micro mobility vehicle as described above is useful if it can autonomously travel while accompanying a user. Furthermore, the moving body is useful if it provides the accompanied user with a sense of security.

The moving body according to the present embodiment suppresses the user’s anxiety by transmitting that the moving body has recognized the user using a human machine interface (HMI) or the like, while accompanying the user even when the moving body does not move.

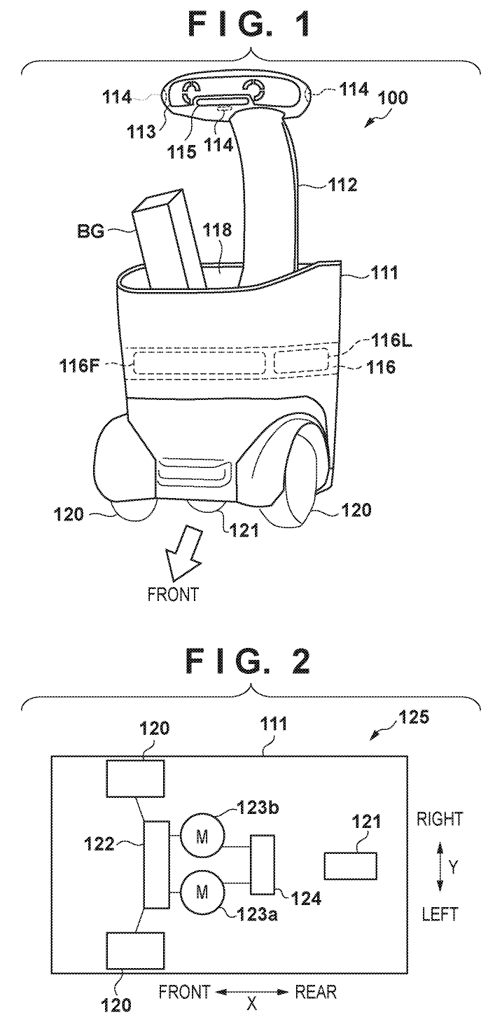

A configuration of a moving body 100 according to the present embodiment will be described with reference to FIG. 1. FIG. 1 is a perspective view illustrating an entire configuration of a moving body. As illustrated in FIG. 1, the moving body 100 according to the embodiment includes a lower housing 111, an upper housing 112, a front display unit 113, a plurality of detection units 114, a sound output unit 115, a light emission unit 116, two driving wheels 120, and a driven wheel 121. Note that the side on which the driving wheels 120 are provided will be referred to as a front side.

The lower housing 111 rotatably holds the driving wheels 120 and the driven wheel 121, and also accommodates a traveling unit including the driving wheels 120 and the driven wheel 121. An upper portion of the lower housing 111 includes a loading space 118 capable of loading a user’s baggage BG. The lower housing 111 accommodates the light emission unit 116. An area of the lower housing 111 that accommodates the light emission unit 116 is made of a light-transmissive material.

The upper housing 112 is configured to extend upward from a rear portion of the lower housing 111. The upper housing 112 supports the front display unit 113, the detection units 114, and the sound output unit 115 at an upper end portion.

The front display unit 113 notifies the user of information using an image. The front display unit 113 may be a display device that displays an image, such as a liquid crystal display device or an organic electro luminescence (EL) display device. The front display unit 113 is provided on the front side of an upper end of the upper housing 112. The front display unit 113 is directed forward. The front display unit 113 notifies the user of information by displaying an image imitating a face of a person, characters, and the like.

The plurality of detection units 114 detects target objects such as people and objects in the surroundings of the moving body 100. Each detection unit 114 may be a digital camera including an optical system such as a lens, an image sensor, and the like. The detection unit 114 images the surroundings and outputs image data. The detection unit 114 may include a device capable of detecting an object, such as a radar and a light detection and ranging (LiDAR), instead of or in addition to the camera. The detection units 114 are provided, for example, on the front, rear, left, and right of the upper end portion of the upper housing 112. As a result, the detection units 114 can capture images of the surroundings in all directions of the moving body 100 (that is, 360° around it) and generate images. Note that the installation positions and the number of the detection units 114 are not particularly limited, and may be appropriately changed.

The sound output unit 115 notifies surrounding people, such as the user, of information using sound. The sound output unit 115 may be a sound output device such as a speaker.

The light emission unit 116 notifies surrounding people, such as the user, of information using light. The light emission unit 116 includes, for example, one or a plurality of light-emitting elements such as light emitting diodes (LED). The light emission unit 116 is provided to surround the lower housing 111. The light emission unit 116 may emit light of a plurality of colors. The light emission unit 116 can emit light of a different color for each area or direction. That is, the light emission unit 116 emits light of a different color for each of a front area 116F, a left area 116L, and a right area, for example. In addition, the light emission unit 116 can switch between light emission and turning off for each area. Note that light emission in the area may be controlled in a finer area.

The two driving wheels 120 are provided on the left and right of a front lower portion of the lower housing 111. The driving wheels 120 rotate around the axles by the driving force transmitted from the traveling unit.

The driven wheel 121 is provided at a rear and lower central portion of the lower housing 111. The driven wheel 121 is held turnably around a vertical axis extending in an up-and-down direction.

FIG. 2 is a schematic plan view illustrating a traveling unit 125 of the moving body 100. The traveling unit 125 of the moving body 100 will be described with reference to FIG. 2.

The traveling unit 125 is provided in a lower portion of the lower housing 111. The traveling unit 125 includes the two driving wheels 120, the driven wheel 121, a drive mechanism 122, a motor 123a, a motor 123b, and a battery 124.

The motor 123a and the motor 123b function as drive sources when electric power is supplied from the battery 124, and supply a driving force to the drive mechanism 122. The drive mechanism 122 transmits the driving force supplied from the motor 123a and the motor 123b to the driving wheels 120. As a result, the drive mechanism 122 rotates the driving wheels 120 to move the moving body 100 forward or backward. The drive mechanism 122 creates a rotation difference between the motor 123a and the motor 123b to set the traveling direction of the moving body 100 to either the left side or the right side. The drive mechanism 122 changes the magnitude of the rotation difference to achieve various turns of the moving body 100 such as a pivot turn, a slow turn, and a spin turn.

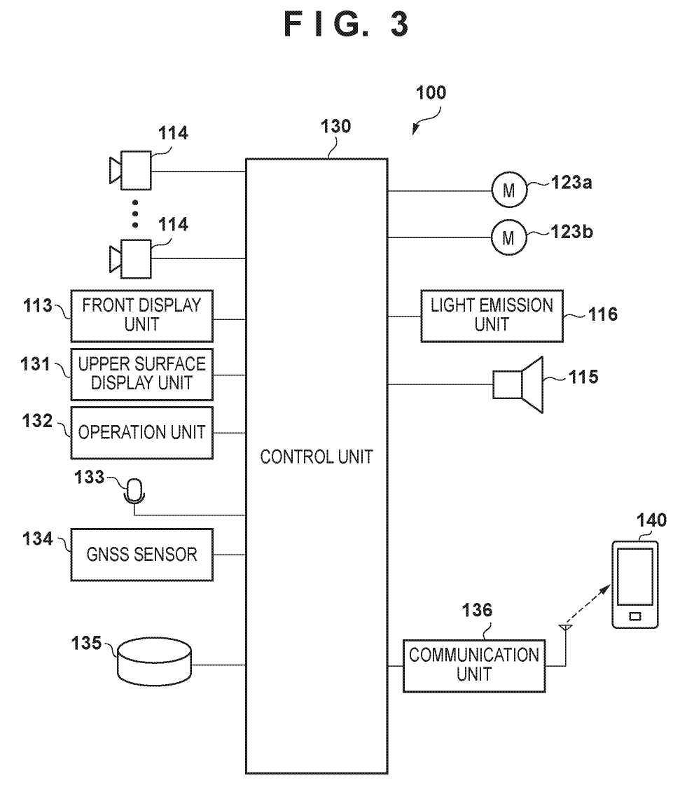

FIG. 3 is a block diagram of a control system of the moving body 100. The control system of the moving body 100 will be described with reference to FIG. 3. As illustrated in FIG. 3, the moving body 100 further includes a control unit 130, an operation unit 132, an upper surface display unit 131, a sound input unit 133, a GNSS sensor 134, a storage device 135, and a communication unit 136.

The control unit 130 is an example of a control device, is also called an electronic control unit (ECU), and may be a computer. The control unit 130 conducts overall control of the moving body 100. The control unit 130 includes one or more processors represented by a central processing unit (CPU), a memory device such as a semiconductor memory, an interface with an external device, and the like.

Instead of or in addition to the CPU, the processor may be a micro processing unit (MPU), a graphics processing unit (GPU), a neural processing unit (NPU), a quantum processing unit (QPU), or the like. The processor reads and executes a computer program stored in a memory device or the like, and achieves various functions of the control unit 130.

Some or all of the functions of the control unit 130 may be achieved by one or a plurality of circuits, such as an application specific integrated circuit (ASIC) and a programmable logic device (PLD) including a field programmable gate array (FPGA).

The memory device may be, for example, a random access memory (RAM). The memory device stores programs to be executed by the processor, data to be used for processing by the processor, and the like. A plurality of sets of the processors, the memory devices, and the interfaces may be provided for the respective functions of the moving body 100, and each set may be configured to be communicable with each other.

The control unit 130 acquires output such as image information output from the detection units 114, user input information acquired by the operation unit 132, sound information output by the sound input unit 133, and the like, and executes processing corresponding to each piece of the information. The control unit 130 controls the motor 123a and the motor 123b of the traveling unit 125 to execute behavior control including traveling of the moving body 100. The control unit 130 notifies the user or surrounding people of information. For example, the control unit 130 controls display of images to be displayed on the front display unit 113 and the upper surface display unit 131 to notify the user of information. The control unit 130 may notify the user of information using light emitted from the light emission unit 116. The control unit 130 may notify the user of information using sound output from the sound output unit 115. The control unit 130 may execute processing using a machine learning model for image recognition (for example, a deep neural network) on image information from the detection units 114. In addition, the control unit 130 may execute processing using a machine learning model for sound recognition (for example, a deep neural network) on sound information from the sound input unit 133.

The upper surface display unit 131 may be a display device capable of displaying an image. The upper surface display unit 131 is provided on an upper surface of an upper end of the upper housing 112. The upper surface display unit 131 displays images, characters, and the like related to information that the user is to be notified of, based on the image information acquired from the control unit 130. The upper surface display unit 131 displays, for example, an operation screen for receiving an operation from the user.

The operation unit 132 may be an input device such as a touch panel or a keyboard. The operation unit 132 is provided, for example, on the display surface of the upper surface display unit 131. The operation unit 132 receives an input from the user, and outputs the input to the control unit 130.

The sound input unit 133 may be a microphone or the like. The sound input unit 133 collects sound of the user and the surroundings of the moving body 100, and outputs the collected sound to the control unit 130.

The GNSS sensor 134 receives a GNSS signal from a satellite, and detects the current position of the moving body 100. Note that GNSS is an abbreviation for global navigation satellite system.

The storage device 135 includes a nonvolatile memory medium that stores various types of data. The storage device 135 may be a hard disk drive (HDD), a solid state drive (SSD), or the like. The storage device 135 may store programs to be executed by the processor, parameters necessary for executing the programs, data to be processed by the processor, and the like. The storage device 135 may store various parameters (for example, learned parameters of the deep neural network, hyperparameters, and the like) of the machine learning model for sound recognition or image recognition to be executed by the control unit 130.

The communication unit 136 communicates with an external device such as a communication terminal 140 of the user via wireless communication such as Wi-Fi or the 5th generation mobile communication system.

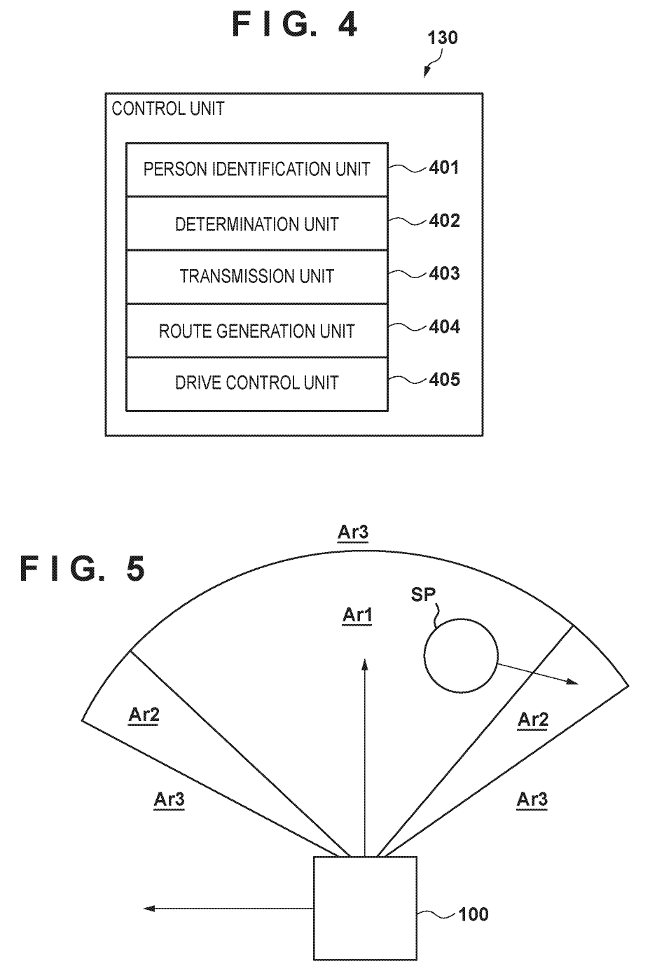

FIG. 4 is a functional block diagram illustrating functions of the control unit 130. The functions of the control unit 130 will be described with reference to FIG. 4.

The control unit 130 includes a person identification unit 401, a determination unit 402, a transmission unit 403, a route generation unit 404, and a drive control unit 405. For example, the control unit 130 may read a program for position change processing from the storage device 135, and execute the program to achieve the person identification unit 401, the determination unit 402, the transmission unit 403, the route generation unit 404, and the drive control unit 405.

The person identification unit 401 identifies the user who is a person to be identified (also referred to as a specific person) and the position of the user to generate position information related to the position. The position mentioned here may be a current position of the user. The position of the user may be a position with the moving body 100 as an origin. For example, the position of the user may be identified using a rotation coordinate system with the moving body 100 as the origin, using the distance from the moving body 100 and the front of the moving body 100 as 0°. In addition, the position of the user may be identified using an orthogonal coordinate system with the moving body 100 as the origin. The position information may have information related to the speed of the user, the orientation of the user's face or body, and the like. The user is a person who is led or followed by the moving body 100. For example, the person identification unit 401 may execute face authentication on an image acquired from the detection units 114 to identify the user. The person identification unit 401 may identify the user using palm vein authentication, iris authentication, fingerprint authentication, or the like.

The determination unit 402 determines, based on the position information related to the identified position of the user, whether the user is in a dead zone area, a response area, or a traveling area. The dead zone area is an example of a first area. The response area is an example of a second area. The traveling area is an example of a third area.

FIG. 5 is a plan view for explaining a dead zone area, a response area, and a traveling area. As illustrated in FIG. 5, the dead zone area, the response area, and the traveling area are set around the moving body 100. In FIG. 5, a position where the moving body 100 is present is defined as a center, and a periphery of the center is defined as a circumferential direction.

A dead zone area Ar1 is an area where the moving body 100 does not operate when a user SP is in this area. For example, when the user SP is in the dead zone area Ar1, the moving body 100 does not drive the motors 123a and 123b and does not move and turn. The dead zone area Ar1 is formed in a fan shape spreading from the direct front to the right and left. The central angle of the dead zone area Ar1 is not particularly limited, but may be, for example, 50° to 120°. The dead zone area Ar1 may have a line-symmetric fan shape, with the direction directly in front of the moving body 100 as a target axis.

The response area Ar2 is an area where the moving body 100 drives the motors 123a and 123b to operate when the user SP is in this area. The operation mentioned here may be a turn including a spin turn without movement. The response area Ar2 is formed in a fan shape extending continuously from each side of the dead zone area Ar1 in the circumferential direction. The central angle of the response area Ar2 is not particularly limited, but may be, for example, 10° to 30°. The radius of the response area Ar2 may be the same as the radius of the dead zone area Ar1.

The traveling area Ar3 is an area where the moving body 100 autonomously travels to follow or lead the user SP when the user SP is in this area. The traveling area Ar3 is formed outside so as to surround the periphery of the dead zone area Ar1 and the response area Ar2.

The determination unit 402 may determine whether the user is in which area based on the current position of the user. In addition, the determination unit 402 may determine whether the user will be in which area in the future based on a predicted position predicted based on the position information including the current position of the user and the like. The predicted position may be a position after a preset time. The preset time may be a few seconds (for example, 3 seconds to 7 seconds). The determination unit 402 may calculate the predicted position of the user based on the current position of the user, the speed of the user calculated from the current position of the user and the like, the orientation of the face or the body of the user, and the like. The determination unit 402 may determine whether the user is in which area based on the distance from the moving body 100 to the user indicated by the position of the user and the angle of the user. Note that the angle of the user may be a rotation angle from the front in the circumferential direction when the front of the moving body 100 is 0°. The determination unit 402 outputs a determination result to the transmission unit 403.

When the determination result indicates that the user is in the dead zone area, the transmission unit 403 transmits recognition information indicating that the user has been recognized to the user. The transmission unit 403 can transmit the recognition information using a plurality of transmission methods different from each other. For example, the transmission unit 403 may transmit the recognition information to the user using an optical method, a method using sound, a method of sending a notification to the communication terminal 140 of the user, or the like. Specifically, the transmission unit 403 may notify the user of the recognition information by at least one or a combination of the front display unit 113, the sound output unit 115, the light emission unit 116, and the communication unit 136. The front display unit 113, the sound output unit 115, the light emission unit 116, and the communication unit 136 are examples of an output unit, a first transmission method, and a second transmission method.

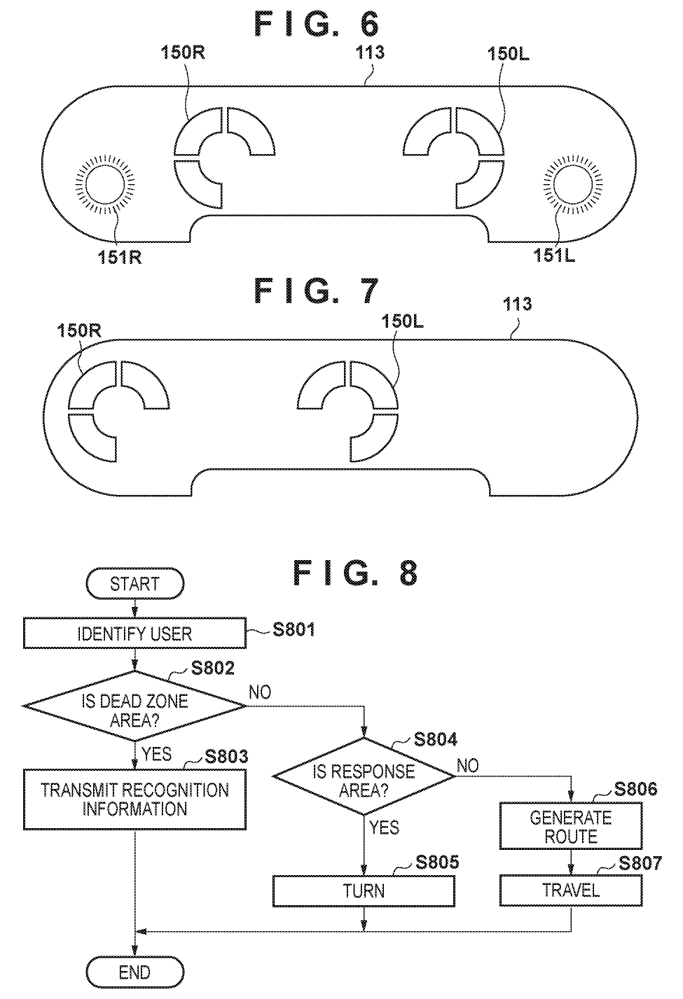

For example, the transmission unit 403 may transmit the recognition information by displaying an image imitating both eyes of a human on the front display unit 113. FIG. 6 is a diagram illustrating an image displayed as recognition information on the front display unit 113 when the user is in front. FIG. 7 is a diagram illustrating an image displayed as recognition information on the front display unit 113 when the user is on the right side. As illustrated in FIG. 6, when the user is directly in front of the moving body 100 in the dead zone area, the transmission unit 403 arranges an image of a pair of a right eye 150R and a left eye 150L imitating both eyes at the center of the front display unit 113. When the user is on the right side of the moving body 100 in the dead zone area, the image of the pair of the right eye 150R and the left eye 150L is moved to the right side of the front display unit 113. As a result, the user can understand that the moving body 100 has recognized that the user is on the right side of the moving body 100.

The transmission unit 403 may output sound from the sound output unit 115 to transmit that the moving body 100 has recognized the user. For example, the transmission unit 403 may transmit the recognition information by outputting sound, such as “What is in the direction of...?”, “Let's walk faster”, “Why are you stopped?”, or “I can see you on the right”.

The transmission unit 403 may transmit the recognition information using a light emission state of the light emission unit 116. For example, the transmission unit 403 may transmit the recognition information by emitting light from an area of the light emission unit 116 corresponding to the position of the user. Specifically, when the user moves from the front of the moving body 100 to the left side, the transmission unit 403 may switch the light emission of the front area 116F of the light emission unit 116 to the light emission of the left area 116L to transmit the recognition. Note that, if the light emitting area of the light emission unit 116 can be finely controlled, the transmission unit 403 may gradually move the light emitting area of the light emission unit 116 to the left side as the user moves to the left side. In addition, the transmission unit 403 may make the color of the light emitted from the area corresponding to the direction in which the user is present different from the color of light of other areas. Furthermore, the transmission unit 403 may project a pointing image that continues to follow the direction of the user on the road surface by emitting light from the light emission unit 116.

The transmission unit 403 may control the color or shape of light emitted from the light emission unit 116 based on any one of a characteristic color and a characteristic shape of the user. For example, the transmission unit 403 may control the color of light to be emitted according to the characteristic color of the user. Specifically, if the user wears red clothes, the transmission unit 403 may recognize the characteristic color as red and set the color of light emitted from the light emission unit 116 to red. The transmission unit 403 may control the shape of the light emitting area according to the characteristic shape (for example, the shape of the body) of the user.

The transmission unit 403 may transmit the recognition information by sending a message or the like to the communication terminal 140 of the user via the communication unit 136. The message may be, for example, “You have XX minutes until your next appointment. Let's hurry”. In addition, the message may have the same content as the messages using sound described above.

When the user is approaching the moving body 100, the transmission unit 403 may display an image indicating that a cheek 151R and a cheek 151L are flushed as illustrated in FIG. 6.

The route generation unit 404 generates a route on which the moving body 100 travels (hereinafter, also referred to as a movement route). For example, when the user is in the traveling area, the route generation unit 404 generates a movement route for following or leading the user.

The drive control unit 405 controls the motor 123a and the motor 123b to control the drive of the moving body 100. The drive mentioned here includes traveling and turning of the moving body 100.

The drive control unit 405 may turn the moving body 100 based on the position information indicating the position of the user. For example, when the position of the user is in the response area Ar2, the drive control unit 405 may rotate the motor 123a and the motor 123b in opposite directions to each other to cause the moving body 100 to perform a spin turn (also referred to as a pivot turn) without moving. Note that the drive control unit 405 may turn the moving body 100 in a manner other than a spin turn.

For example, as illustrated in FIG. 7, when the position of the user is in the right-side response area, the drive control unit 405 causes the moving body 100 to turn rightward. The drive control unit 405 may stop the rotation of the motor 123a and the motor 123b when the position of the user changes to the dead zone area by the turning. As a result, the moving body 100 continues to turn due to inertia, and the user further approaches the front of the moving body 100. Note that the drive control unit 405 may turn the moving body 100 until the user is positioned in front of the moving body 100.

When the user is in the traveling area Ar3, the drive control unit 405 may cause the moving body 100 to travel along the movement route generated by the route generation unit 404. When the position of the user is in the traveling area Ar3, the drive control unit 405 may control the motor 123a and the motor 123b to cause the moving body 100 to travel along the movement route. The traveling mentioned here may be following traveling to follow the user.

With reference to FIG. 8, drive control processing according to the embodiment to be executed by the control unit 130 will be described. FIG. 8 is a flowchart illustrating a processing flow of drive control processing according to the embodiment. The drive control processing is an example of a method for controlling the moving body 100.

As illustrated in FIG. 8, in the drive control processing, in S801, the person identification unit 401 identifies the user and the current position of the user. The person identification unit 401 outputs position information related to the identified user to the determination unit 402.

In S802, the determination unit 402 determines whether the user is in the dead zone area based on the current position indicated by the position information related to the user. When the determination unit 402 has determined that the user is in the dead zone area (S802: Yes), the processing proceeds to step S803. On the other hand, when the determination unit 402 has determined that the user is not in the dead zone area (S802: No), the processing proceeds to step S804.

In S803, the transmission unit 403 transmits recognition information indicating that the moving body 100 has recognized the user to the user. For example, when the user is on the right side in the dead zone area, the transmission unit 403 may display an image as illustrated in FIG. 7 on the front display unit 113. In addition, the transmission unit 403 may output a message such as “I can see you on the right” using sound. The transmission unit 403 may emit light from an area of the light emission unit 116 corresponding to the direction in which the user is present.

In S804, the determination unit 402 determines whether the user is in the response area based on the position of the user. When the determination unit 402 has determined that the user is in the response area (S804: Yes), the processing proceeds to step S805. On the other hand, when the determination unit 402 has determined that the user is not in the response area, that is, the user is in the traveling area (S804: No), the processing proceeds to step S806.

In S805, the drive control unit 405 rotationally drives the motor 123a and the motor 123b to turn the moving body 100 so that the user approaches the front of the moving body 100. For example, the drive control unit 405 may cause the moving body 100 to perform a spin turn without moving the moving body 100.

In step S806, the route generation unit 404 generates a movement route for following or leading the user.

In S807, the drive control unit 405 rotationally drives the motor 123a and the motor 123b to cause the moving body 100 to travel along the movement route generated by the route generation unit 404. The traveling mentioned here may be following traveling to follow the user.

As a result, the control unit 130 terminates the drive control processing.

Hereinafter, a modification of the drive control processing will be described. Note that, in the following drive control processing, the description of processing similar to that in the above-described embodiment will be omitted or simplified. The following drive control processing may be installed in the moving body 100 together with the above-described drive control processing. In this case, the moving body 100 can execute a plurality of types of drive control processing. The control unit 130 may select and execute one of the plurality of types of drive control processing according to a surrounding situation or the like. In addition, the control unit 130 may select and execute one of the plurality of types of drive control processing based on an operation instruction input by the user.

### First Modification

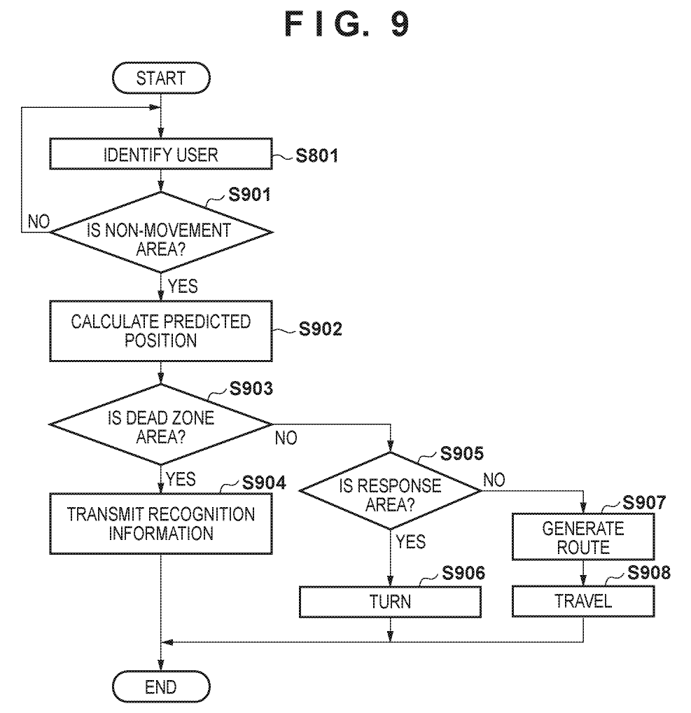

In a first modification, it is determined whether the position of the user is in which area based on the predicted position. FIG. 9 is a flowchart illustrating a processing flow of drive control processing according to the first modification. The drive control processing according to the first modification to be executed by the control unit 130 will be described with reference to FIG. 9.

In the drive control processing according to the first modification, the control unit 130 executes S801.

In S901, the determination unit 402 determines whether the position of the user is in a non-movement area based on the position of the user. The non-movement area may be an area combining the dead zone area and the response area, and is an area where the moving body 100 is not moved. The determination unit 402 may perform the determination based on the distance from the moving body 100 to the user indicated by the position of the user, and the angle of the user from the front of the moving body 100. When the determination unit 402 has determined that the user is not in the non-movement area (S901: No), the processing in and after step S801 is repeated. On the other hand, when the determination unit 402 has determined that the user is in the non-movement area (S901: Yes), the processing proceeds to step S902.

In S902, the determination unit 402 calculates and predicts a position (referred to as a predicted position) of the user based on user information. The user information includes, for example, the position, the speed, and the orientation of the user.

In S903, the determination unit 402 determines whether the predicted position of the user is in the dead zone area. When the determination unit 402 has determined that the predicted position is in the dead zone area (S903: Yes), the processing proceeds to step S904. On the other hand, when the determination unit 402 has determined that the predicted position is not in the dead zone area (S903: No), the processing proceeds to step S905.

In S904, the transmission unit 403 transmits the recognition information based on the predicted position. For example, when the predicted position is on the right side of the moving body 100, the transmission unit 403 may move the right eye 150R and the left eye 150L to the right side as illustrated in FIG. 7. The transmission unit 403 may transmit the recognition information by the sound output unit 115 and the light emission unit 116.

In S905, the determination unit 402 determines whether the predicted position of the user is in the response area. When the determination unit 402 has determined that the predicted position of the user is in the response area (S905: Yes), the processing proceeds to step S906. On the other hand, when the determination unit 402 has determined that the predicted position of the user is not in the response area, that is, the predicted position is in the traveling area (S905: No), the processing proceeds to step S907.

In S906, the drive control unit 405 rotationally drives the motor 123a and the motor 123b, and causes the moving body 100 to perform a spin turn so that the predicted position of the user approaches the front.

In S907, the route generation unit 404 generates a movement route for following or leading the user based on the predicted position of the user.

In S908, the drive control unit 405 causes the moving body 100 to travel along the movement route generated by the route generation unit 404.

As a result, the control unit 130 terminates the drive control processing.

### Second Modification

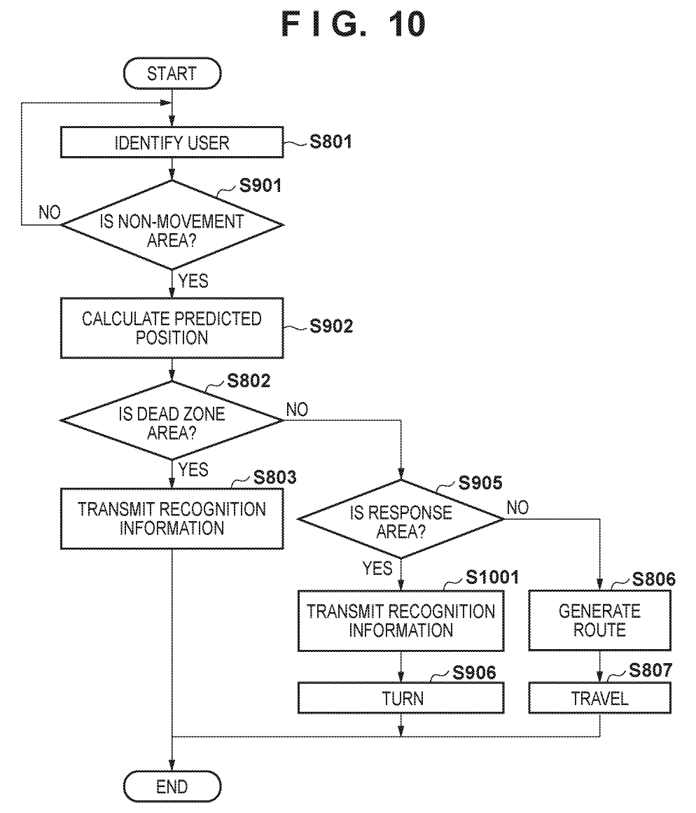

In a second modification, it is determined whether the position of the user is in which area based on either the current position or the predicted position. In other words, the second modification is a combination of the embodiment and the first modification. FIG. 10 is a flowchart illustrating a processing flow of drive control processing according to the second modification. The drive control processing according to the second modification will be described with reference to FIG. 10.

In the drive control processing according to the second modification, the control unit 130 executes S801 to S902, and then the processing proceeds to S802.

In S802, the determination unit 402 determines whether the user is in the dead zone area based on the current position of the user. When the determination unit 402 has determined that the current position of the user is in the dead zone area, the processing proceeds to step S803. On the other hand, when the determination unit 402 has determined that the current position of the user is not in the dead zone area, the processing proceeds to step S905.

In S803, the transmission unit 403 transmits the recognition information based on the current position of the user.

In S905, the determination unit 402 determines whether the predicted position of the user is in the response area. When the determination unit 402 has determined that the predicted position of the user is in the response area (S905: Yes), the processing proceeds to step S1001. On the other hand, when the determination unit 402 has determined that the predicted position of the user is not in the response area (S905: No), the processing proceeds to step S806.

In S1001, the transmission unit 403 transmits the recognition information based on the predicted position of the user. Here, the transmission unit 403 may transmit the recognition information to the user using a transmission method different from step S803. For example, when the recognition information has been transmitted by displaying an image on the front display unit 113 in S803, the transmission unit 403 may transmit the recognition information using sound in S1001. A sound message here may be, for example, “I’m going to move with you”. In addition, when the recognition information has been transmitted by displaying an image on the front display unit 113 in S803, the transmission unit 403 may transmit the recognition information to the user by displaying a different image on the front display unit 113 in S1001.

In S906, the drive control unit 405 causes the moving body 100 to turn so that the predicted position of the user approaches the front.

In S806, the route generation unit 404 generates a movement route for following or leading the user based on the current position of the user.

In S807, the drive control unit 405 causes the moving body 100 to travel along the movement route generated by the route generation unit 404.

As a result, the control unit 130 terminates the drive control processing.

As described above, in the embodiment and the modifications (hereinafter, referred to as the embodiment), when the user is in the dead zone area, information indicating that the moving body has recognized the user is transmitted. As a result, in the embodiment, it is possible to notify the user that the moving body 100 has recognized the user, whereby it is possible to reduce the user’s anxiety in the dead zone area.

In the embodiment, the moving body 100 turns so as to face the user when the user is in the response area. As a result, according to the embodiment, when the user moves to the traveling area where the moving body travels, it is possible to achieve autonomous traveling, such as following traveling, with less delay.

In the embodiment, an image to be displayed on the front display unit 113, a sound message to be output from the sound output unit 115, and a light emitting area of the light emission unit 116 are changed according to the position of the user. As a result, according to the embodiment, it is possible to transmit that the moving body 100 has recognized where the user is in the dead zone area to the user. As a result, according to the embodiment, it is possible to further reduce the user’s anxiety.

According to the embodiment, since the position information of the user includes the current position, it is possible to determine the position, transmit the recognition information, and the like according to the current position.

According to the embodiment, since the recognition information is transmitted using an optical method such as an image, it is possible to more reliably transmit the recognition information to the user.

According to the embodiment, since the recognition information is transmitted using a method using sound, it is possible to more reliably transmit the recognition information to the user.

According to the embodiment, since the recognition information is transmitted by sending a notification to the communication terminal 140 of the user, it is possible to more reliably transmit the recognition information to the user.

According to the embodiment, since the transmission unit 403 has a plurality of transmission methods, it is possible to select a transmission method for the recognition information according to the situation.

In the second modification, the transmission unit 403 has a plurality of transmission methods, and transmits the recognition information using different methods in S803 and S1001. As a result, according to the second modification, it is possible to achieve the transmission of the recognition information according to the situation.

According to the embodiment, since it is determined that the user is in the dead zone area based on the current position, it is possible to transmit the recognition information according to the current position of the user.

According to the first modification, since it is determined that the user moves from the dead zone area to the response area based on the predicted position, it is possible to further reduce the delay of the moving body 100.

According to the embodiment, since the recognition information indicating that the moving body has recognized the specific person is transmitted based on the characteristic color and the characteristic shape of the user, it is possible for the user to understand that the user has been recognized.

According to the embodiment, since the moving body 100 is caused to travel when the user is in the traveling area, it is possible for the moving body 100 to follow the user.

### Other Modifications

The above-described embodiment and modifications may be appropriately combined. If the embodiment and the modifications are combined, the user may select a combined form. In addition, the user may combine a part of the embodiment and a part of the modifications.

In the above-described modifications, the processing is executed based on one predicted position, but the number of predicted positions is not limited to one. The determination unit 402 may predict a plurality of predicted positions at different times. For example, the determination unit 402 may predict predicted positions after four seconds and six seconds. In this case, the transmission unit 403 may change a transmission method of the recognition information based on the plurality of predicted positions.

For example, when the predicted position after six seconds is in the dead zone area, the transmission unit 403 displays an image of the right eye 150R and the left eye 150L looking in the direction of the user on the front display unit 113 as illustrated in FIG. 7. On the other hand, when the predicted position after four seconds moves from the dead zone area to the response area, the transmission unit 403 may display an image in which the left eye 150L is closed and the right eye 150R is opened on the front display unit 113, and the drive control unit 405 may cause the moving body 100 to turn (for example, perform a spin turn) toward the user.

In the above-described embodiment, the recognition information is transmitted when the position of the user is in the dead zone area. However, when the user is in the dead zone area for a predetermined threshold time or more, or longer than the threshold time, the recognition information may be transmitted.

In the above-described embodiment, the recognition information is transmitted when the position of the user is in the dead zone area. However, when the amount of the movement of the user in the dead zone area is a predetermined threshold amount or more, or larger than the threshold amount, the recognition information may be transmitted.

Note that in the above-described embodiment, the case where the control device is the control unit 130 of the moving body 100 has been described as an example. However, the control device may be included in, for example, an information processing server present outside the moving body 100. In this case, the control device may execute a part or all of the processing executed by the above-described control unit 130 while communicating with the moving body 100. That is, the present embodiment is also applicable to a case where the moving body 100 is remotely controlled from a device separate from the moving body 100.

### Summary of Embodiments

1. A control method for controlling a moving body, the moving-body control method comprising:

identifying position information related to a position of a specific person (for example S401 and S801);

determining, based on the position information, whether the specific person is in a first area where the moving body does not operate or a second area where the moving body operates (for example S402 and S802); and

transmitting, when it has been determined that the specific person is in the first area, recognition information indicating that the moving body has recognized the specific person (for example S403 and S803).

As a result, according to the embodiment, it is possible to notify the specific person that the moving body has recognized the specific person, whereby it is possible to reduce the anxiety of the specific person in the first area.

2. In the embodiment,

when it has been determined that the specific person is in the first area, a transmission method is changed according to the position of the specific person (S805).

As a result, according to the embodiment, it is possible to transmit to the specific person that the moving body has recognized where the specific person is in the first area.

3. In the embodiment,

when it has been determined that the specific person is in the second area, the moving body is caused to turn so as to face the specific person (S805).

As a result, according to the embodiment, when the specific person moves to an area where the moving body travels, it is possible to achieve autonomous traveling, such as following traveling, with less delay.

4. In the embodiment,

the transmitting the recognition information includes a first transmission method and a second transmission method different from the first transmission method (S803 and S1001).

As a result, according to the embodiment, it is possible to select a transmission method of the recognition information according to the situation.

5. In the embodiment,

when the specific person is in the first area, the recognition information is transmitted using the first transmission method, and

when the specific person moves from the first area to the second area, the recognition information is transmitted using the second transmission method while the moving body is caused to turn (S803 and S1001).

As a result, according to the embodiment, it is possible to achieve the transmission of the recognition information according to the situation.

6. In the embodiment,

determination that the specific person is in the first area is performed based on a current position of the specific person indicated by the position information (S803).

As a result, according to the embodiment, it is possible to transmit the recognition information according to the current position of the specific person.

7. In the embodiment,

determination that the specific person moves from the first area to the second area is performed based on a predicted position of the specific person indicated by the position information (S905).

As a result, according to the embodiment, since the movement from the first area to the second area is determined based on the predicted position, it is possible to further reduce the delay of the moving body.

8. In the embodiment,

the transmitting the recognition information is performed using an optical method (S803).

As a result, according to the embodiment, since the recognition information is transmitted using the optical method such as an image, it is possible to more reliably transmit the recognition information to the specific person.

9. In the embodiment,

the transmitting the recognition information is performed using sound (S803).

As a result, according to the embodiment, since the recognition information is transmitted using a method using sound, it is possible to more reliably transmit the recognition information to the specific person.

10. In the embodiment,

the transmitting the recognition information is performed by sending a notification to a terminal of the specific person (S803).

As a result, according to the embodiment, since the recognition information is transmitted by sending a notification to the terminal of the specific person, it is possible to more reliably transmit the recognition information to the specific person.

11. In the embodiment,

the position information includes information on a current position of the specific person (S801).

As a result, according to the embodiment, since the position information of the specific person includes the current position, it is possible to determine the position, transmit the recognition information, and the like according to the current position.

12. In the embodiment,

the recognition information based on at least one of a characteristic color and a characteristic shape of the specific person is transmitted (S803).

As a result, according to the embodiment, it is possible for the specific person to more understand that the specific person has been recognized.

13. In the embodiment,

when the specific person is in a third area outside the first area and the second area, the moving body is caused to travel based on the position of the specific person (S806 and S807).

As a result, according to the embodiment, since the moving body is caused to travel when the specific person is in the third area, it is possible for the moving body to follow the specific person.

The invention is not limited to the foregoing embodiments, and various variations/changes are possible within the spirit of the invention.

What is claimed is:

1. A control method for controlling a moving body, the moving-body control method comprising:
identifying position information related to a position of a specific person;
determining, based on the position information, whether the specific person is in a first area where the moving body does not operate or a second area where the moving body operates; and
transmitting, when it has been determined that the specific person is in the first area, recognition information indicating that the moving body has recognized the specific person.

2. The moving-body control method according to claim 1, wherein when it has been determined that the specific person is in the first area, a transmission method is changed according to the position of the specific person.

3. The moving-body control method according to claim 1, wherein when it has been determined that the specific person is in the second area, the moving body is caused to turn so as to face the specific person.

4. The moving-body control method according to claim 1, wherein the transmitting the recognition information includes a first transmission method and a second transmission method different from the first transmission method.

5. The moving-body control method according to claim 4, wherein
when the specific person is in the first area, the recognition information is transmitted using the first transmission method, and
when the specific person moves from the first area to the second area, the recognition information is transmitted using the second transmission method while the moving body is caused to turn.

6. The moving-body control method according to claim 5, wherein determination that the specific person is in the first area is performed based on a current position of the specific person indicated by the position information.

7. The moving-body control method according to claim 5, wherein determination that the specific person moves from the first area to the second area is performed based on a predicted position of the specific person indicated by the position information.

8. The moving-body control method according to claim 1, wherein the transmitting the recognition information is performed using an optical method.

9. The moving-body control method according to claim 1, wherein the transmitting the recognition information is performed using sound.

10. The moving-body control method according to claim 1, wherein the transmitting the recognition information is performed by sending a notification to a terminal of the specific person.

11. The moving-body control method according to claim 1, wherein the position information includes information on a current position of the specific person.

12. The moving-body control method according to claim 1, wherein the recognition information based on at least one of a characteristic color and a characteristic shape of the specific person is transmitted.

13. The moving-body control method according to claim 1, wherein when the specific person is in a third area outside the first area and the second area, the moving body is caused to travel based on the position of the specific person.

14. A control device for controlling a moving body, the moving-body control device comprising:
an identification unit configured to identify position information related to a position of a specific person;
a determination unit configured to determine, based on the position information, whether the specific person is in a first area where the moving body does not operate or a second area where the moving body operates; and
a transmission unit configured to transmit, when it has been determined that the specific person is in the first area, recognition information indicating that the moving body has recognized the specific person.

15. A moving body comprising:
an identification unit configured to identify position information related to a position of a specific person;
a determination unit configured to determine, based on the position information, whether the specific person is in a first area where the moving body does not operate or a second area where the moving body operates; and
a transmission unit configured to transmit, when it has been determined that the specific person is in the first area, recognition information indicating that the moving body has recognized the specific person; and
an output unit configured to output recognition information.

16. A non-transitory computer-readable storage medium storing a program causing a computer to execute the moving-body control method according to claim 1.
